(19) United States
(12) Patent Application Publication
(10) Pub. No.: US 2013/0090182 A1
(43) Pub. Date: Apr. 11, 2013

(54) GOLF CLUB HEAD OR OTHER BALL STRIKING DEVICE WITH ADJUSTABLE WEIGHTING

(71) Applicants: Raymond J. Sander, Benbrook, TX (US); Robert Lukasiewicz, JR., Portland, OR (US)

(72) Inventors: Raymond J. Sander, Benbrook, TX (US); Robert Lukasiewicz, JR., Portland, OR (US)

(73) Assignee: Nike, Inc., Beaverton, OR (US)

(21) Appl. No.: 13/269,254

(22) Filed: Oct. 7, 2011

(51) Int. Cl. A63B 53/06; A63B 53/04; B23P 11/00; A63B 53/00

(52) U.S. Cl. 473/291; 473/350; 473/334; 29/428

(57) ABSTRACT

A ball striking device, such as a golf club, includes a head that includes a face having a ball striking surface configured for striking a ball and a body connected to the face and extending rearward from the face. The face may be defined by a plurality of peripheral edges. The body has a receiver therein, and a weight member is connected to the body and is at least partially received by the receiver. The weight member is formed of a polymer material having a doping material embedded therein, with the doping material having a different density than the polymer material. Additionally, the weight member has connecting structure that engages a portion of the body to retain the weight member to the receiver.

### TECHNICAL FIELD

The invention relates generally to ball striking devices, such as golf clubs and heads. Certain aspects of this invention relate to golf clubs and golf club heads having at least one receiver and at least one weight member connected to the head and at least partially received in the receiver.

### BACKGROUND

Golf is enjoyed by a wide variety of players—players of different genders, and players of dramatically different ages and skill levels. Golf is somewhat unique in the sporting world in that such diverse collections of players can play together in golf outings or events, even in direct competition with one another (e.g., using handicapped scoring, different tee boxes, etc.), and still enjoy the golf outing or competition. These factors, together with increased golf programming on television (e.g., golf tournaments, golf news, golf history, and/or other golf programming) and the rise of well known golf superstars, at least in part, have increased golfs popularity in recent years, both in the United States and across the world.

Golfers at all skill levels seek to improve their performance, lower their golf scores, and reach that next performance “level.” Manufacturers of all types of golf equipment have responded to these demands, and recent years have seen dramatic changes and improvements in golf equipment. For example, a wide range of different golf ball models now are available, with some balls designed to fly farther and straighter, provide higher or flatter trajectory, provide more spin, control, and feel (particularly around the greens), etc.

Being the sole instrument that sets a golf ball in motion during play, the golf club also has been the subject of much technological research and advancement in recent years. For example, the market has seen improvements in golf club heads, shafts, and grips in recent years. Additionally, other technological advancements have been made in an effort to better match the various elements of the golf club and characteristics of a golf ball to a particular user's swing features or characteristics (e.g., club fitting technology, ball launch angle measurement technology, etc.).

Despite the various technological improvements, golf remains a difficult game to play at a high level. For a golf ball to reliably fly straight and in the desired direction, a golf club should meet the golf ball square (or substantially square) to the desired target path. Moreover, the golf club should meet the golf ball at or close to a desired location on the club head face (i.e., on or near a “desired” or “optimal” ball contact location) to reliably fly straight, in the desired direction, and for a desired distance. Off-center hits that deviate from squared contact and/or are located away from the club's desired ball contact location may tend to “twist” the club face when it contacts the ball, thereby sending the ball in the wrong direction, often imparting undesired hook or slice spin, and/or robbing the shot of distance. Accordingly, club head features that can help a user keep the club face square with the ball would tend to help the ball fly straighter and truer, in the desired direction, and often with improved and/or reliable distance.

Various golf club heads have been designed to improve a golfer's accuracy by assisting the golfer in squaring the club head face at impact with a golf ball. When the club face is not square at the point of engagement, the golf ball may fly in an unintended direction and/or may follow a route that curves left or right, ball flights that are often referred to as “pulls,” “pushes,” “draws,” “fades,” “hooks,” or “slices,” or may exhibit more boring or climbing trajectories. The distance and direction of ball flight can also be significantly affected by the spin imparted to the ball by the impact with the club head. Additionally, the spin of the ball can change the behavior of the ball as it rolls and bounces after impact with the ground. Various speeds and directions of spin on the ball can be a product of many factors, including the point of impact, the direction of the club head upon impact, the degree of twisting of the club head upon impact, and the location of the center of gravity of the club head.

The energy and velocity transferred to the ball by a golf club also may be related, at least in part, to the flexibility of the club face at the point of contact, and can be expressed using a measurement called “coefficient of restitution” (or “COR”). The maximum COR for golf club heads is currently limited by the USGA at 0.83. Generally, a club head will have an area of highest response relative to other areas of the face, such as having the highest COR, which imparts the greatest energy and velocity to the ball, and this area is typically positioned at the center of the face. In one example, the area of highest response may have a COR that is equal to the prevailing USGA limit (e.g. 0.83), which may change over time. However, because golf clubs are typically designed to contact the ball at or around the center of the face, off-center hits may result in less energy being transferred to the ball, decreasing the distance of the shot.

The weighting and weight distribution of a golf club head may also influence the energy and velocity transferred to the ball by the impact, as well as the moment of inertia and the center of gravity of the club head. The moment of inertia of the head can be increased, for example, by distributing a greater amount of weight around the perimeter of the head. This, in turn, can reduce the amount of twisting of the club head that occurs on off-center hits, and increase the distance and accuracy of shots on off-center hits. Likewise, the location of the center of gravity of the head can be influenced by the weight distribution of the head. Generally, the desired contact area of the face is aligned with the center of gravity of the head. However, it may be desirable to shift the location of the center of gravity of the head, such as to adjust for common off-center hitting patterns by a golfer, or to produce a certain shot characteristic (e.g., hook, slice, draw, fade, etc.). Accordingly, club head features that can permit the weighting and weight distribution of the head to be adjusted or customized may provide improved performance in several ways.

The present device and method are provided to address the problems discussed above and other problems, and to provide advantages and aspects not provided by prior ball striking devices of this type. A full discussion of the features and advantages of the present invention is deferred to the following detailed description, which proceeds with reference to the accompanying drawings.

### BRIEF SUMMARY

The following presents a general summary of aspects of the invention in order to provide a basic understanding of the invention. This summary is not an extensive overview of the invention. It is not intended to identify key or critical elements of the invention or to delineate the scope of the invention. The following summary merely presents some concepts of the invention in a general form as a prelude to the more detailed description provided below.

Aspects of the invention relate to ball striking devices, such as golf clubs, with a head that includes a face having a ball striking surface configured for striking a ball and a body connected to the face and extending rearward from the face. The face may be defined by a plurality of peripheral edges. The body has a receiver therein, and a weight member is connected to the body and is at least partially received by the receiver. The weight member is formed of a polymer material having a doping material embedded therein, with the doping material having a different density than the polymer material. Additionally, the weight member has connecting structure that engages a portion of the body to retain the weight member to the receiver.

According to one aspect, the head is an iron-type golf club head, and the body includes a sole member extending rearward from a bottom edge of the face and a rear wall connected to the sole member. In this configuration, the receiver is positioned in the rear wall of the body.

According to another aspect, where the head is an iron-type golf club head, the body further includes a plurality of peripheral walls (including the sole member) extending rearward from the peripheral edges of the face, and a cavity defined between the peripheral walls, the rear wall, and an inner surface of the face, such that at least a portion of the rear wall is spaced from the inner surface of the face.

According to a further aspect, the head is an iron-type golf club head with a blade-type configuration, such that the body further includes a plurality of peripheral walls (including the sole member) extending rearward from the peripheral edges of the face. The peripheral walls and the rear wall combine to form a solid body, and the receiver extends from the rear wall into the solid body.

According to yet another aspect, the head is a wood-type golf club head, and the body includes an inner cavity enclosed by the body and the face. The body has a sole surface, and the receiver is located in the sole surface of the body.

According to still further aspects, the connecting structure of the weight member includes at least one of the following: a flexible tab that engages the rear wall to retain the weight member to the receiver; a threaded portion that engages complementary threading in the receiver to retain the weight member to the receiver; a bonding material between the weight member and the receiver to retain the weight member to the receiver; and a fastener that engages the body to retain the weight member to the receiver.

According to an additional aspect, the head also includes a second weight member formed of a polymer material having a doping material embedded therein, where the doping material of the second weight member has a different density than the polymer material, and the second weight member has a different density than the original weight member. The second weight member is configured for connection to the body in place of the original weight member, such that the second weight member is at least partially received by the receiver, and the second weight member has connecting structure configured to engage the portion of the body to retain the second weight member to the receiver.

According to other aspects, the receiver has a generally oval shape that is elongated in a heel-to-toe direction, and the weight member has a generally oval shape that is complementary to the shape of the receiver to be received in the receiver.

According to still other aspects, the weight member may have a weight gradient such that one portion of the weight member has a higher density than another portion of the weight member. For example, the weight member may include a second doping material having a higher density than the first doping material, and the two doping materials can distributed within the weight member so as to create the weight gradient. As another example, the doping material may be unevenly distributed within the weight member to create the weight gradient, such as by having an uneven volume fraction.

Additional aspects of the invention relate to an iron-type golf club head that includes a face defined by a plurality of peripheral edges including a bottom edge, the face having a ball striking surface and an inner surface opposite the ball striking surface, and a body connected to the face and extending rearward from the face. The body includes a sole member extending rearward from the bottom edge of the face, a rear wall extending upward from a rear of the sole member, and a rear cavity defined at least partially by the sole member, the rear wall, and the inner surface of the face. The rear wall has a receiver therein, and a weight member is connected to the rear wall and is at least partially received by the receiver. The weight member has connecting structure that engages the rear wall to retain the weight member to the receiver. Additionally, the weight member is formed of a polymer material having a doping material embedded therein, the doping material having a different density than the polymer material.

According to one aspect, the receiver has a generally oval shape that is elongated in a heel-to-toe direction, and the weight member has a generally oval shape that is complementary to the shape of the receiver to be received in the receiver.

According to another aspect, the connecting structure of the weight member includes at least one of the following: a fastener that engages the rear wall to retain the weight member to the receiver, a flexible tab that engages the rear wall to retain the weight member to the receiver, a threaded portion that engages complementary threading in the receiver to retain the weight member to the receiver, and/or a bonding material between the weight member and the receiver to retain the weight member to the receiver.

According to a further aspect, the head further includes a second weight member formed of a polymer material having a doping material embedded therein, with the doping material of the second weight member having a different density than the polymer material, and the second weight member having a different density than the original weight member. The second weight member is configured for connection to the rear wall in place of the original weight member, such that the second weight member is at least partially received by the receiver. Additionally, the second weight member has connecting structure configured to engage the rear wall to retain the second weight member to the receiver. In one embodiment, the weight member and the second weight member are part of a plurality of weight members. Each weight member includes a polymer material having a doping material embedded therein, and the doping material of the each weight member has a different density than the polymer material. Additionally, each weight member has a different density than each of the other weight members. The plurality of weight members are configured for alternate connection to the rear wall, such that each weight member is at least partially received by the receiver when connected to the rear wall. In another embodiment, the connecting structure of the weight member and the connecting structure of the second weight member are substantially identical. According to a further embodiment, the doping material of the weight member is different from the doping material of the second weight member and has a different density than the doping material of the second weight member.

Further aspects of the invention relate to a set of iron-type golf clubs that includes a first iron-type golf club having an iron-type golf club head and a second iron-type golf club having a second iron-type golf club head. The first golf club head and the second golf club head each include a face defined by a plurality of peripheral edges, including a bottom edge, and having a ball striking surface and an inner surface opposite the ball striking surface, and a body connected to the face and extending rearward from the face. The body of each head includes a sole member extending rearward from the bottom edge of the face, a rear wall extending upward from a rear of the sole member, and a rear cavity defined at least partially by the sole member, the rear wall, and the inner surface of the face. The rear wall of each head has a receiver therein, and a weight member is connected to the rear wall and is at least partially received by the receiver. The weight member has connecting structure that engages the rear wall to retain the weight member to the receiver of the respective head. Additionally, the weight members are formed of a polymer material having a doping material embedded therein, the doping material having a different density than the polymer material. The ball striking surface of the second club has a face angle that is different from a face angle of the ball striking surface of the first golf club.

According to one aspect, the weight member of the first golf club and the weight member of the second golf club are interchangeable with each other.

According to another aspect, the weight member of the first golf club has a connecting structure that engages the rear wall to retain the weight member to the receiver, and the second golf club has a connecting structure that engages the rear wall to retain the weight member to the receiver. The connecting structure of the weight member of the first golf club and the connecting structure of the weight member of the second golf club are substantially identical, to enable the weight members to be interchanged.

According to a further aspect, the weight member of the first golf club and the weight member of the second golf club are part of a plurality of weight members that are interchangeable with each other and are each configured to be connected to the rear wall of the first and second golf clubs such that at least a portion of the weight member is received by the receiver of the respective golf club. In one embodiment, each of the plurality of weight members has a different density.

Further aspects of the invention relate to a kit that includes a golf club head that includes a face defined by a plurality of peripheral edges and having a ball striking surface configured for striking a ball, and a body connected to the face and extending rearward from the peripheral edges of the face, with the body having a receiver therein. A plurality of weight members are each configured for alternate connection to the body, such that each weight member is at least partially received by the receiver when connected to the body. Additionally, each weight member is formed of a polymer material having a doping material embedded therein, with the doping material of each weight member having a different density than the polymer material, and each weight member having a different weighting than each other weight member. The weight members have a different weighting than each other weight member if the member have at least one of a different total weight, a different average density, and a different weight distribution.

According to another aspect, the doping material of a first of the weight members is a different material than the doping material of a second of the weight members, with the doping material of the first weight member having a different density than the doping material of the second weight member.

According to a further aspect, a first of the weight members has a greater volume fraction of doping material than a second of the weight members.

According to yet another aspect, each weight member has connecting structure configured to engage a portion of the body to retain the weight member to the receiver. In one embodiment, all of the weight members have substantially identical connecting structure.

Still further aspects of the invention relate to a method that includes providing a golf club head as described above, and connecting a weight member to the body, such that the weight member is at least partially received by the receiver. The weight member includes a polymer material having a doping material embedded therein, with the doping material having a different density than the polymer material.

According to one aspect, the method also includes removing the weight member from the body, and connecting a second weight member to the body to replace the weight member. The second weight member is at least partially received by the receiver, and the second weight member is formed of a polymer material having a doping material embedded therein, the doping material having a different density than the polymer material.

According to another aspect, the method also includes providing a plurality of weight members each being configured for alternate connection to the body. Each weight member is at least partially received by the receiver when connected to the body, each weight member includes a polymer material having a doping material embedded therein. The doping material of each weight member has a different density than the polymer material, and each weight member has a different density than each other weight member. One weight member is selected from the plurality of weight members, based on a weighting of the weight member, prior to connecting the weight member to the body.

Other aspects of the invention relate to golf clubs that include a golf club head as described above and a shaft connected to the head, or a set of golf clubs including at least one golf club having a head as described above.

Other features and advantages of the invention will be apparent from the following description taken in conjunction with the attached drawings.

### BRIEF DESCRIPTION OF THE DRAWINGS

To allow for a more full understanding of the present invention, it will now be described by way of example, with reference to the accompanying drawings in which:

FIG. 1 is a front view of an illustrative embodiment of an iron-type ball striking device according to aspects of the present invention;

FIG. 2 is a front view of an illustrative embodiment of a head of the ball striking device of FIG. 1;

FIG. 3 is a rear view of the head of FIG. 2, along with a plurality of weight members configured for connection to the head;

FIG. 4 is a cross-section view of the head of FIG. 3, taken along lines 4-4 of FIG. 3;

FIG. 5 is a cross-section view of one illustrative embodiment of a weight member configured for use with an iron-type ball striking head as illustrated in FIG. 2;

FIG. 6 is a cross-section view of a second illustrative embodiment of a weight member configured for use with an iron-type ball striking head as illustrated in FIG. 2;

FIG. 7 is a cross-section view of a third illustrative embodiment of a weight member configured for use with an iron-type ball striking head as illustrated in FIG. 2;

FIG. 8 is a cross-section view of the head as shown in FIG. 4, with the weight member of FIG. 5 connected thereto;

FIG. 9 is a cross-section view of the head as shown in FIG. 4, with the weight member of FIG. 6 connected thereto;

FIG. 10 is a cross-section view of the head as shown in FIG. 4, with the weight member of FIG. 7 connected thereto;

FIG. 11 is a rear view of a second illustrative embodiment of a head of an iron-type ball striking device according to aspects of the present invention;

FIG. 12 is a cross-section view of the head of FIG. 11, taken along lines 12-12 of FIG. 11;

FIG. 13 is a rear view of a third illustrative embodiment of a head of an iron-type ball striking device according to aspects of the present invention;

FIG. 14 is a cross-section view of the head of FIG. 13, taken along lines 14-14 of FIG. 13;

FIG. 15 is a rear view of a fourth illustrative embodiment of a head of an iron-type ball striking device according to aspects of the present invention;

FIG. 16 is a cross-section view of the head of FIG. 15, taken along lines 16-16 of FIG. 15;

FIG. 17 is a magnified plan view of a connecting structure of a fourth embodiment of a weight member and an embodiment of a head of a ball-striking device configured for connection with the weight member;

FIG. 18 is a rear view of a fifth illustrative embodiment of a head of an iron-type ball striking device according to aspects of the present invention;

FIG. 19 is a cross-section view of the head of FIG. 18, taken along lines 19-19 of FIG. 18;

FIG. 20 is a rear view of a sixth illustrative embodiment of a head of an iron-type ball striking device according to aspects of the present invention, along with a plurality of weight members configured for connection to the head;

FIG. 21 is a rear view of a seventh illustrative embodiment of a head of an iron-type ball striking device according to aspects of the present invention, along with a weight member configured for connection to the head;

FIG. 21A is a rear view of an eighth illustrative embodiment of a head of an iron-type ball striking device according to aspects of the present invention;

FIG. 22 is a front view of an illustrative embodiment of a head of a wood-type ball striking device according to aspects of the present invention; and FIG. 23 is a bottom view of the head of FIG. 22.

### DETAILED DESCRIPTION

In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention. Also, while the terms “top,” “bottom,” “front,” “back,” “side,” “rear,” and the like may be used in this specification to describe various example features and elements of the invention, these terms are used herein as a matter of convenience, e.g., based on the example orientations shown in the figures or the orientation during typical use. Additionally, the term “plurality,” as used herein, indicates any number greater than one, either disjunctively or conjunctively, as necessary, up to an infinite number. Nothing in this specification should be construed as requiring a specific three dimensional orientation of structures in order to fall within the scope of this invention. Also, the reader is advised that the attached drawings are not necessarily drawn to scale.

The following terms are used in this specification, and unless otherwise noted or clear from the context, these terms have the meanings provided below.

“Ball striking device” means any device constructed and designed to strike a ball or other similar objects (such as a hockey puck). In addition to generically encompassing “ball striking heads,” which are described in more detail below, examples of “ball striking devices” include, but are not limited to: golf clubs, putters, croquet mallets, polo mallets, baseball or softball bats, cricket bats, tennis rackets, badminton rackets, field hockey sticks, ice hockey sticks, and the like.

“Ball striking head” means the portion of a “ball striking device” that includes and is located immediately adjacent (optionally surrounding) the portion of the ball striking device designed to contact the ball (or other object) in use. In some examples, such as many golf clubs and putters, the ball striking head may be a separate and independent entity from any shaft or handle member, and it may be attached to the shaft or handle in some manner.

The terms “shaft” and “handle” are used synonymously and interchangeably in this specification, and they include the portion of a ball striking device (if any) that the user holds during a swing of a ball striking device.

“Integral joining technique” means a technique for joining two pieces so that the two pieces effectively become a single, integral piece, including, but not limited to, irreversible joining techniques, such as adhesively joining, cementing, and welding (including brazing, soldering, or the like), where separation of the joined pieces cannot be accomplished without structural damage thereto.

In general, aspects of this invention relate to ball striking devices, such as golf club heads, golf clubs, putter heads, putters, and the like. Such ball striking devices, according to at least some examples of the invention, may include a ball striking head and a ball striking surface. In the case of a golf club, the ball striking surface is a substantially flat surface on one face of the ball striking head. Some more specific aspects of this invention relate to iron-type golf clubs and golf club heads, including long irons, short irons, wedges, etc. Alternately, some aspects of this invention may be practiced with hybrid clubs, chippers, and the like, or wood-type golf clubs and the like.

According to various aspects of this invention, the ball striking device may be formed of one or more of a variety of materials, such as metals (including metal alloys), ceramics, polymers, composites (including fiber-reinforced composites), and wood, and may be formed in one of a variety of configurations, without departing from the scope of the invention. In one illustrative embodiment, some or all components of the head, including the face and at least a portion of the body of the head, are made of metal. It is understood that the head may contain components made of several different materials, including carbon-fiber and other components. Additionally, the components may be formed by various forming methods. For example, metal components (such as titanium, aluminum, titanium alloys, aluminum alloys, steels (including stainless steels), and the like) may be formed by forging, molding, casting, stamping, machining, and/or other known techniques. In another example, composite components, such as carbon fiber-polymer composites, can be manufactured by a variety of composite processing techniques, such as prepreg processing, powder-based techniques, mold infiltration, and/or other known techniques.

The various figures in this application illustrate examples of ball striking devices according to this invention. When the same reference number appears in more than one drawing, that reference number is used consistently in this specification and the drawings refer to the same or similar parts throughout.

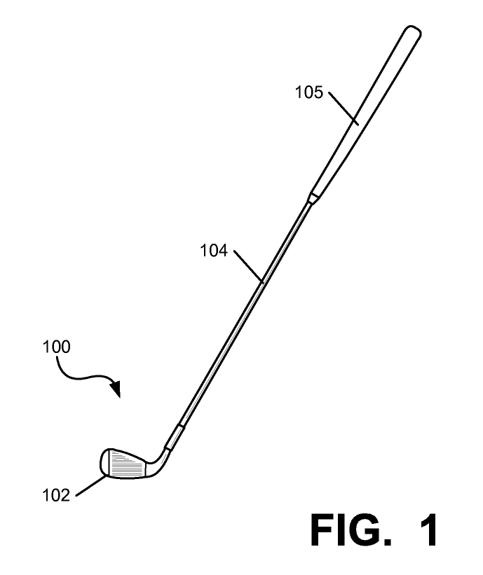

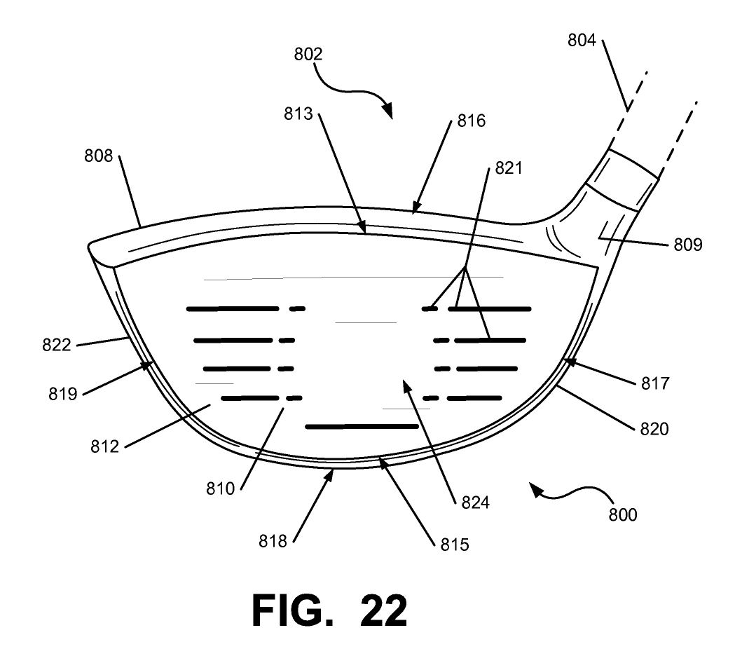

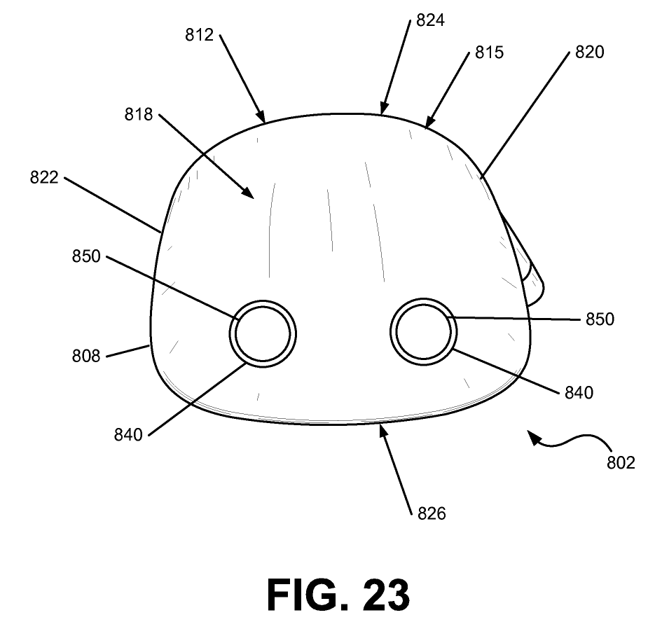

At least some examples of ball striking devices according to this invention relate to golf club head structures, including heads for wood-type golf clubs, such as drivers, as well as long iron clubs (e.g., driving irons, zero irons through five irons), short iron clubs (e.g., six irons through pitching wedges, as well as sand wedges, lob wedges, gap wedges, and/or other wedges), hybrid clubs, and putters. Such devices may include a one-piece construction or a multiple-piece construction. Example structures of ball striking devices according to this invention will be described in detail below in conjunction with FIG. 1, which illustrates an example of a ball striking device 100 in the form of an iron-type golf club, and FIG. 22, which illustrates an example of a ball striking device 800 in the form of a wood-type golf club, in accordance with at least some examples of this invention.

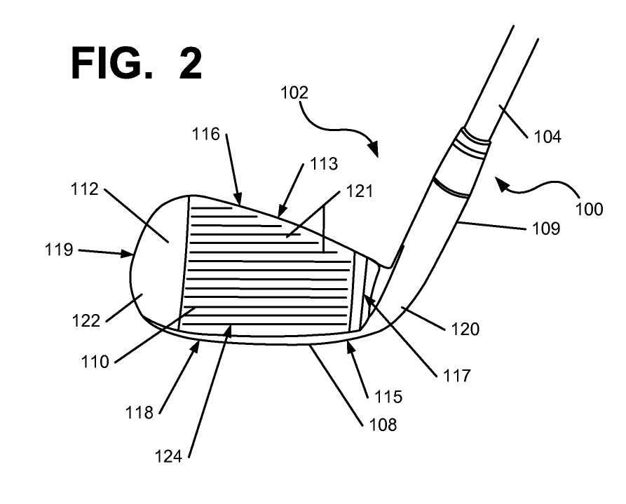

FIG. 1 illustrates a ball striking device 100 in the form of a golf iron, in accordance with at least some examples of this invention, and illustrative embodiments of heads 102, et seq., of ball striking devices 100 of this type are shown in FIGS. 2-21A. The golf club head 102 of FIG. 1 may be representative of any iron-type golf club head in accordance with examples of the present invention. As shown in FIGS. 1-2, the ball striking device 100 includes a ball striking head 102 and a shaft 104 connected to the ball striking head 102 and extending therefrom. The ball striking head 102 of the ball striking device 100 of FIGS. 1-2 has a face 112 connected to a body 108, with a hosel 109 extending therefrom. Any desired hosel and/or head/shaft interconnection structure may be used without departing from this invention, including conventional hosel or other head/shaft interconnection structures as are known and used in the art, or an adjustable, releasable, and/or interchangeable hosel or other head/shaft interconnection structure such as those shown and described in U.S. Pat. No. 6,890,269 dated May 10, 2005, in the name of Bruce D. Burrows, U.S. Published Patent Application No. 2009/0011848, filed on Jul. 6, 2007, in the name of John Thomas Stites, et al., U.S. Published Patent Application No. 2009/0011849, filed on Jul. 6, 2007, in the name of John Thomas Stites, et al., U.S. Published Patent Application No. 2009/0011850, filed on Jul. 6, 2007, in the name of John Thomas Stites, et al., and U.S. Published Patent Application No. 2009/0062029, filed on Aug. 28, 2007, in the name of John Thomas Stites, et al., all of which are incorporated herein by reference in their entireties.

As shown in FIGS. 2-4, the golf club head 102 includes a body member 108 having a face 112 and a hosel 109 extending from the body 108 for attachment of the shaft 104. For reference, the head 102 generally has a top 116, a bottom or sole 118, a heel 120 proximate the hosel 109, a toe 122 distal from the hosel 109, a front 124, and a back or rear 126. The shape and design of the head 102 may be partially dictated by the intended use of the device 100. The heel portion 120 is attached to and/or extends from the hosel 109 (e.g., as a unitary or integral one piece construction, as separate connected elements, etc.). In the embodiment shown in FIGS. 2-4, the body 108 and the hosel 109 are formed as a single, integral piece, such as by casting, forging, etc. The face 112 may also be formed of the same single, integral piece with the body 108 and the hosel 109. In another embodiment, the face 112, the body 108, and/or the hosel 109 may be formed of two or more separate pieces that are connected together by an integral joining technique or another joining technique. In other applications, such as for a different type of golf club, the head may be designed to have different dimensions and configurations.

The face 112 is located at the front 124 of the head 102, and has an outer surface 110, as well as a rear surface 111 located opposite the outer surface 110, which may be considered an inner surface of the face 112. The face 112 is defined by a plurality of peripheral edges, including a top edge 113, a bottom edge 115, a heel edge 117, and a toe edge 119. The face 112 also has a plurality of face grooves 121 on the ball striking surface 110. For reference purposes, the portion of the face 112 nearest the top face edge 113 and the heel 120 of the head 102 is referred to as the “high-heel area”; the portion of the face 112 nearest the top face edge 113 and toe 122 of the head 102 is referred to as the “high-toe area”; the portion of the face 112 nearest the bottom face edge 115 and heel 120 of the head 102 is referred to as the “low-heel area”; and the portion of the face 112 nearest the bottom face edge 115 and toe 122 of the head 102 is referred to as the “low-toe area”. Conceptually, these areas may be recognized and referred to as quadrants of substantially equal size (and/or quadrants extending from a geometric center of the face 112), though not necessarily with symmetrical dimensions. The face 112 may include some curvature in the top to bottom and/or heel to toe directions (e.g., bulge and roll characteristics), as is known and is conventional in the art. As seen in the illustrative embodiments in FIGS. 2-5, the ball striking surface 110 is inclined (i.e., at a loft angle), to give the ball an appreciable degree of lift and spin when struck. In other illustrative embodiments, the ball striking surface 110 may have a different incline or loft angle, to affect the trajectory of the ball.

The body 108 and the face 112 of the golf club head 102 may be constructed from a wide variety of different materials, including materials conventionally known and used in the art, such as steel, titanium, aluminum, tungsten, graphite, polymers, or composites, or combinations thereof. Also, if desired, the club head 102 may be made from any number of pieces (e.g., having a separate face mask, etc.) and/or by any construction technique, including, for example, casting, forging, welding, and/or other methods known and used in the art.

The ball striking device 100 may include a shaft 104 connected to or otherwise engaged with the ball striking head 102, as shown in FIG. 1. The shaft 104 is adapted to be gripped by a user to swing the ball striking device 100 to strike the ball. The shaft 104 can be formed as a separate piece connected to the head 102, such as by connecting to the hosel 109, as shown in FIG. 1. In other illustrative embodiments, at least a portion of the shaft 104 may be an integral piece with the head 102, and/or the head 102 may not contain a hosel 109 or may contain an internal hosel structure. Still further embodiments are contemplated without departing from the scope of the invention. The shaft 104 may be constructed from one or more of a variety of materials, including metals, ceramics, polymers, composites, or wood. In some illustrative embodiments, the shaft 104, or at least portions thereof, may be constructed of a metal, such as stainless steel or titanium, or a composite, such as a carbon/graphite fiber-polymer composite. However, it is contemplated that the shaft 104 may be constructed of different materials without departing from the scope of the invention, including conventional materials that are known and used in the art. A grip element 105 may be positioned on the shaft 104 to provide a golfer with a slip resistant surface with which to grasp golf club shaft 104, as shown in FIG. 1. The grip element 105 may be attached to the shaft 104 in any desired manner, including in conventional manners known and used in the art (e.g., via adhesives or cements, threads or other mechanical connectors, swedging/swaging, etc.).

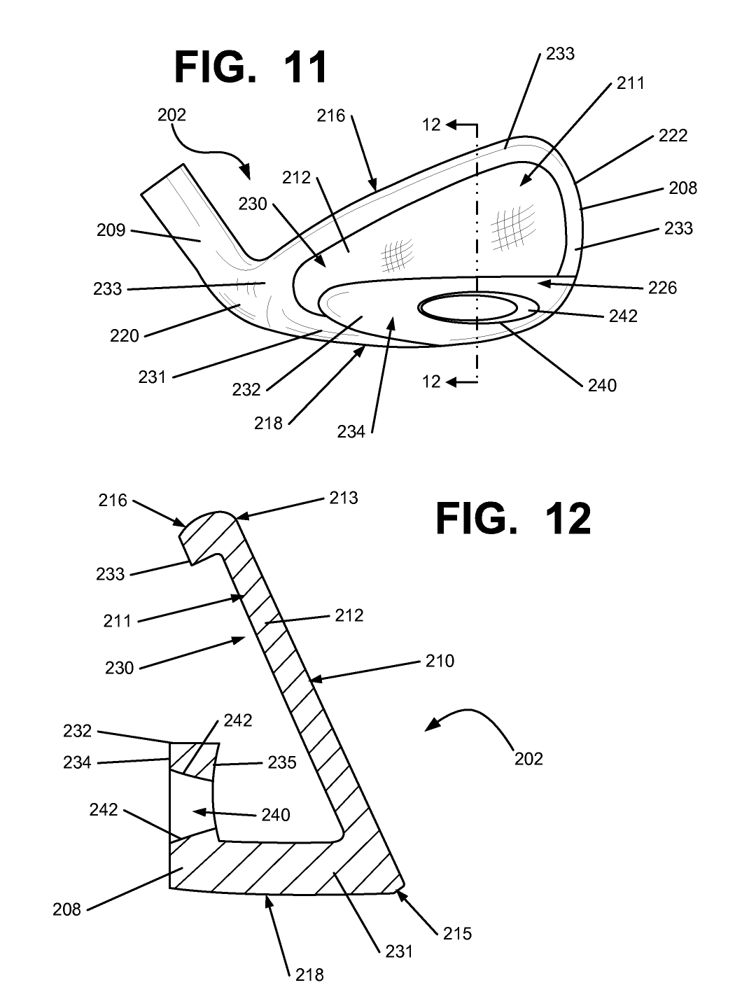

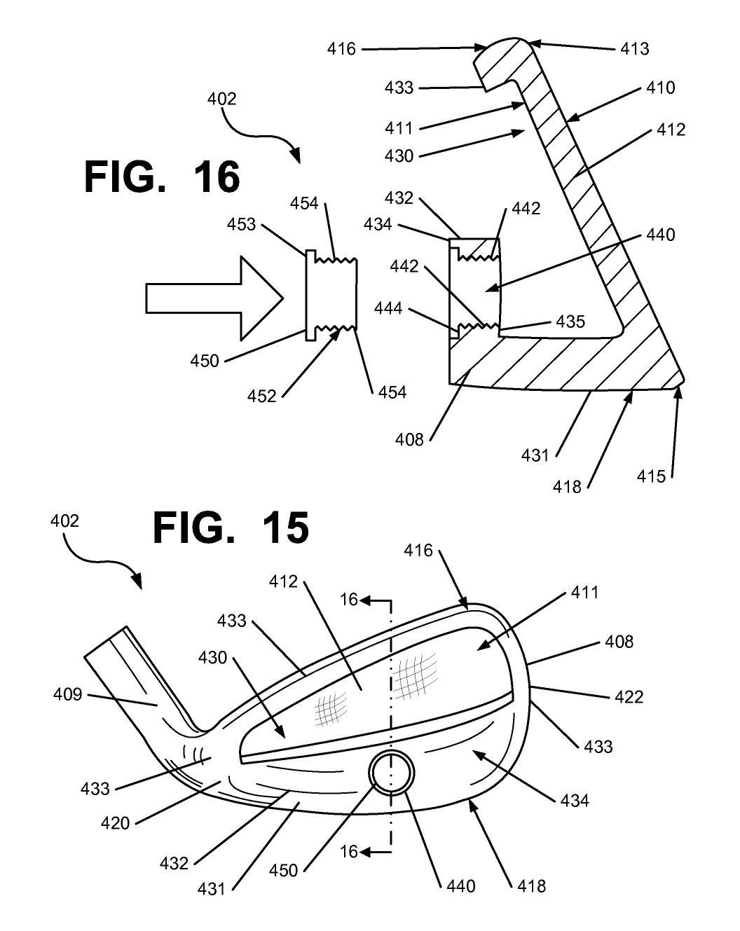

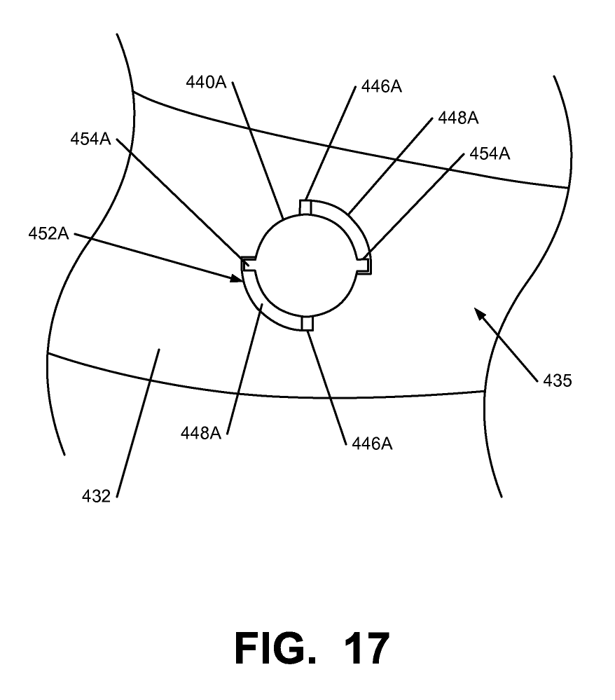

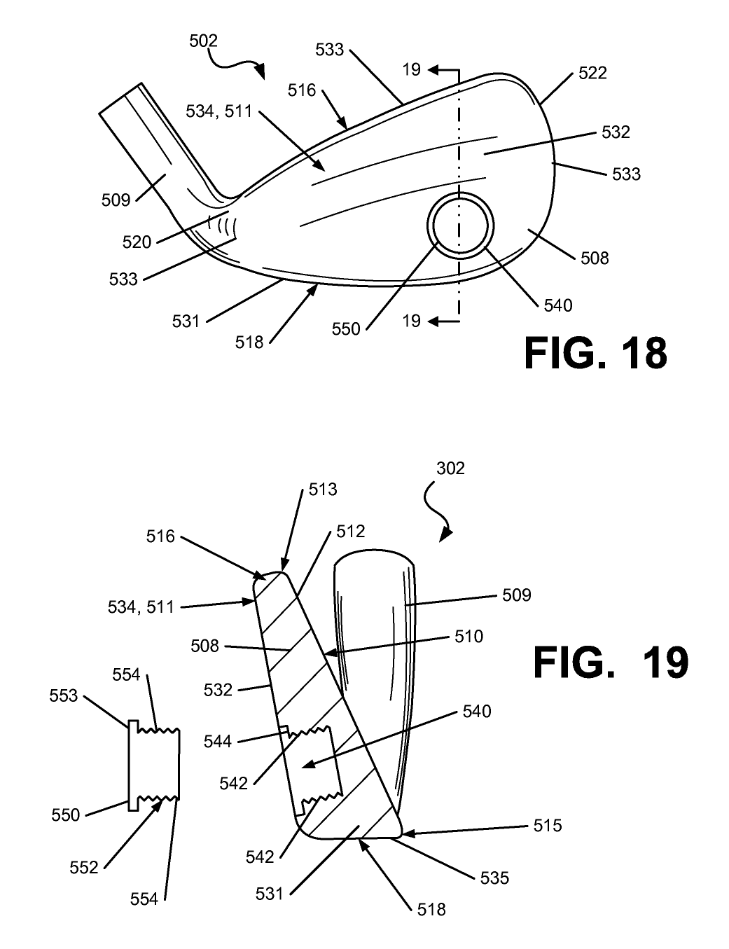

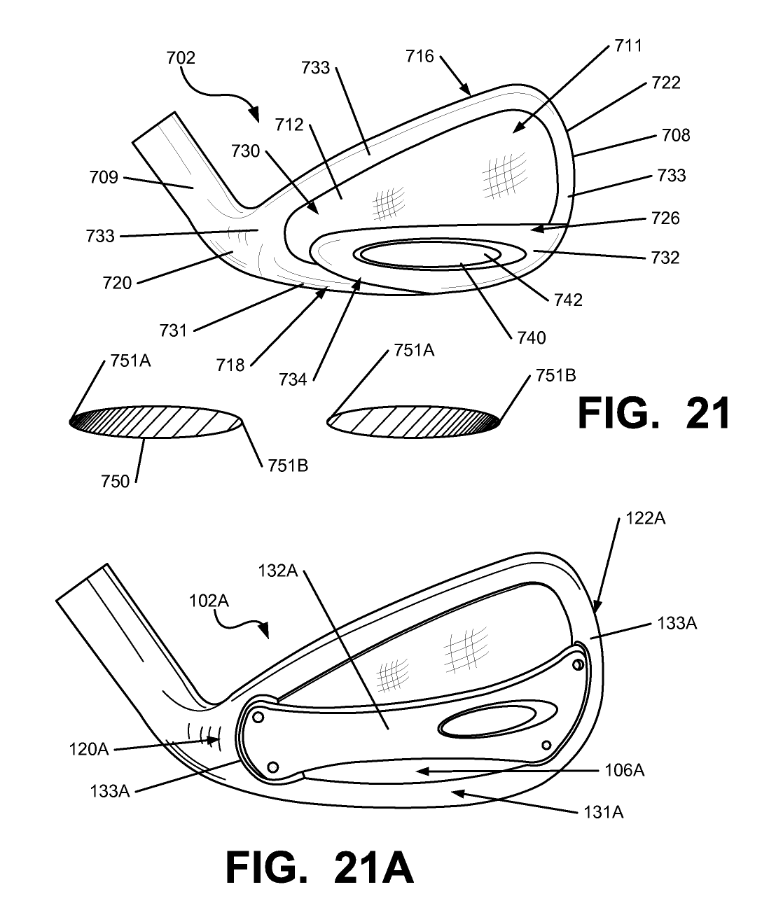

In one exemplary embodiment, shown in FIGS. 2-4, the body 108 of the head 102 includes a rear cavity 130 located behind the face 112, which is defined at least partially by the rear surface 111 of the face 112. As shown in FIGS. 2-4, the body 108 further includes a sole body member 131 extending rearward from the bottom edge 115 of the face 112 and defining a portion of the rear cavity 130. The rear cavity 130 may also be partially defined by peripheral or perimeter walls 133 extending rearward from the peripheral edges of the face 112, including the top edge 113, the heel edge 117, and the toe edge 119 of the face 112. It is understood that the sole member 131, or a portion thereof, may be considered to be a peripheral wall 133 as defined herein. The peripheral walls 133 follow the curvilinear contour of the body 108, and form an opening to the rear cavity 130 defined by the peripheral walls 133, including the sole member 131. Further, the head 102 of FIGS. 2-4 includes a rear wall 132 extending upward from the rear of the sole member 131, and partially defining the rear cavity 130. In the embodiment shown, the rear wall 132 extends a portion of the width of the rear cavity, and is connected to the rear of the sole member 131 and the peripheral wall 133 on the toe side 122 of the head 102. In additional embodiments, the head 102 may have a differently configured sole member, cavity, or rear wall, or may not contain some of these components. For example, the features described herein can be used in connection with the embodiments illustrated in FIGS. 11-21A and other known configurations for club heads, including other iron-type club head configurations, as well as hybrid club heads and wood-type club heads. As described below, the head 402 of FIGS. 15-16 includes a rear wall 432 that extends completely across the rear cavity 430 of the head 402, from the peripheral wall 433 on the heel side 420 to the peripheral wall 433 on the toe side 422, and the head 402 of FIGS. 18-19 has a blade-type configuration with a solid body 508 and no rear cavity. In a further embodiment, the rear wall 132 may be in the form of a bridge member having a gap or opening on the bottom side, such as the rear wall 132A of the head 102A shown in FIG. 21A. In this embodiment, the rear wall 132A is in the form of a bridge member connected to the head 102A by fasteners and extending between the peripheral walls 133A on the heel 120A and the toe 122A of the head 102A, with an opening 106A existing between the sole member 131A and the rear wall 132A. The rear wall 132A has a receiver 140A, similar to other embodiments herein, and it is understood that the position of the receiver 140A may be changed in further embodiments, such as for longer or shorter irons.

In general, the head 102 has at least one weight member 150 connected to the body 108. The body 108 has at least one receiver 140, each receiver 140 being configured for connection of a weight member 150 such that the weight member 150 is at least partially received by receiver 140. The weight member 150 has connecting structure 152 that engages a portion of the body 108 to retain the weight member 150 to the receiver 140. In one embodiment, at least one weight member 150 is formed at least partially of a polymer material having a doping material embedded therein, where the doping material has a different density than the polymer material, as described below. A number of different embodiments illustrating a variety of examples of such different configurations are shown in FIGS. 2-23 and described below.

The weight members 150 described herein may be formed of filled or doped polymer materials, which include a polymer matrix with a filler or doping material dispersed throughout the matrix. Typically, the doping material will have a different density from the polymer material, permitting the weighting of the polymer material to be controlled by the use of the doping material. The use of different doping materials, different polymer materials, and/or different doping configurations can be used to create weight members 150 having identical or substantially identical sizes and shapes, while having different weightings, which may include different weights, densities, and/or weight distributions. For example, two identically-shaped weight members 150 may be formed of the same polymer material and have doping materials of different densities in similar volume fractions, resulting in the two weight members 150 having different weights and densities. The use of different polymer materials provides a further option for creating different weights and densities, in a similar manner. In another example, two identically-shaped weight members 150 may be formed of the same polymer material with the same dense doping material, but with one weight member 150 having a higher volume fraction of the doping material within the polymer, resulting in the two weight members 150 having different weights and densities. In a further example, one or more doping materials may be used in various distributions and/or volume fractions to create a weight member 150 having a weight gradient, such as the weight member 750 shown in FIG. 21 and described below. In a still further example, two identically-shaped weight members 150 may be formed of the same polymer material with the same or different doping materials, with one of the weight members 150 having the doping material evenly distributed throughout the polymer matrix and the other weight member 150 having the doping material distributed more heavily in certain portions of the weight member 150 relative to other portions. In this example, the first weight member 150 has an even weight distribution, where the second weight member has an uneven weight distribution, with the portions of the weight member 150 having a heavier distribution of doping material having greater weight relative to other portions. Still further examples are recognized by those skilled in the art.

A variety of different polymer materials and doping materials can be used in connection with the weight members 150 described herein. Examples of polymer materials suitable for use with the weight members 150 include rubber, thermoplastic polyurethane (TPU) and other polyurethanes, silicones, acrylonitrile butadiene styrenes, polyether block amides, polyamides, high-density polyethylene (HDPE) or other polyethylenes, styrene ethylene butylene styrene, and other polymers and copolymers. Additionally, doping materials having different densities can be used with the weight members 150, and are typically used in powdered or other particulate form. Examples of such doping materials for weight control include any of various metals having different weights or other properties, such as tungsten, stainless steel, brass, copper, etc., as well as non-metals such as various oxides, sulfates, etc. or any other material or combination of such materials having one or more desired properties. In one embodiment, doping materials in various volume fractions can be used to create weight members 150 having substantially identical structure and densities that vary ten-fold, such as from 1.2-12.0 g/cc. In other embodiments, further weights and densities can be achieved. It is understood that the weight member 150 may include more than one polymer material and/or more than one doping material, and that the weight member 150 may have portions that are not formed of the polymer material, such as appendages made of a different material. In one example, a weight member 150 made of tungsten-filled rubber can be used, which can have a density ranging from 1.9-12.0 g/cc. Further, the polymer material of the weight member 150 may be selected based on additional properties. For example, the strength or hardness of the material may affect the rigidity of the head 102, and the flexibility of the material may affect sound and/or vibration dampening properties of the head 102. Other examples are contemplated as well.

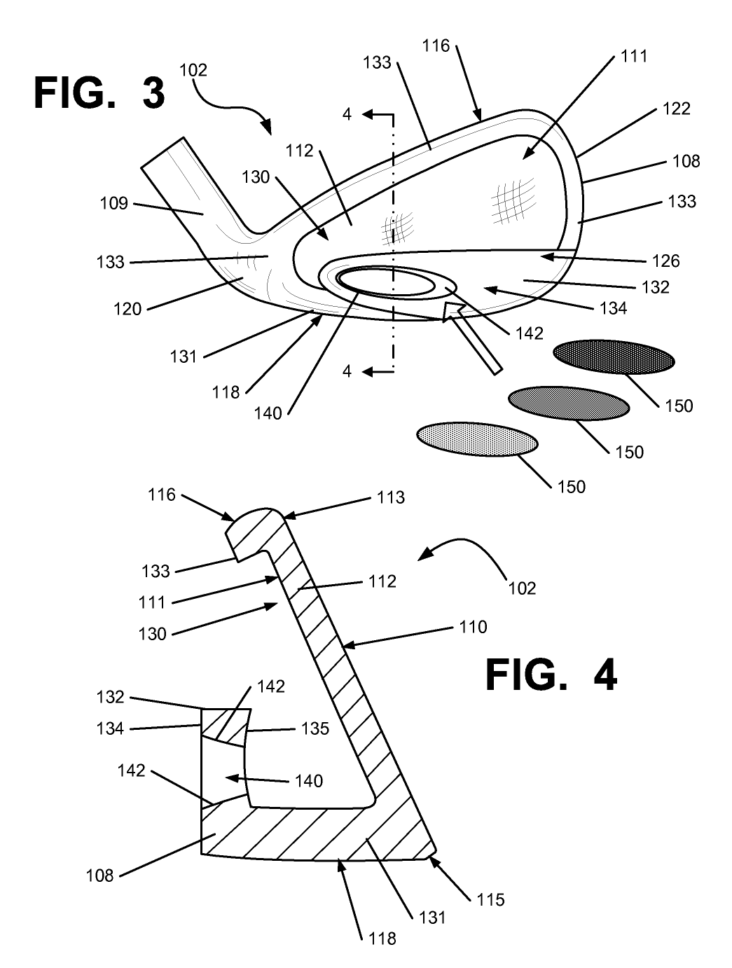

FIGS. 2-4 illustrate one example embodiment of a head 102 in accordance with the present invention. As described above, the head 102 has a body 108 with a face 112 connected to the body 108, with the face 112 having a ball striking surface 110 configured for striking a ball. The body 108 is formed by a plurality of peripheral walls 133 extending rearward from the face 112, including a sole member 131, and a rear wall 132 extending upward from the rear of the sole member 131. The rear wall 132 has a receiver 140 formed therein, as illustrated in FIGS. 3-4. In this embodiment, the receiver 140 is an aperture that extends completely through the rear wall 132, from the outer surface 134 to the inner surface 135 of the rear wall 132, and into the rear cavity 130. As illustrated in FIG. 3, the receiver 140 has an elongated, substantially oval or elliptical shape, and is positioned more proximate the heel 120 than the toe 122, such that the elongated receiver 140 extends from behind the hot zone of the face 112 toward the heel 120. Additionally, the receiver 140 has inner walls 142 defining the aperture through the rear wall 132, and in this embodiment, the inner walls 142 are tapered inwardly from the outer surface 134 to the inner surface 135 of the rear wall 132, as illustrated in FIGS. 3-4. In other embodiments, the receiver 140 may have a different size, shape, structure, position, etc., and additional embodiments are described below. For example, in one embodiment, the receiver 140 may have a bottom, rather than two openings at opposite ends, such as by not extending completely through the rear wall 132.

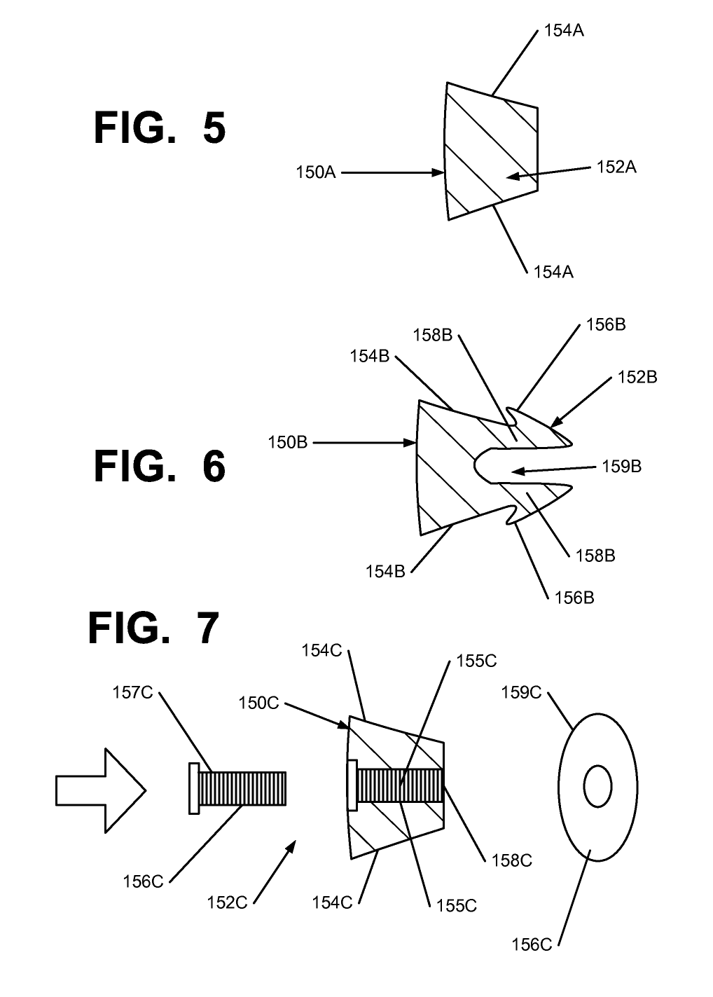

As illustrated in FIG. 3, the receiver 140 is configured to receive at least a portion of a weight member 150 to connect the weight member 150 to the head 102. FIG. 3 shows three different weight members 150, each having substantially identical sizes and shapes, but all having different weighting. Each weight member 150 is formed of a filled polymer material, and each weight member 150 has a different doping material, such that the three weight members 150 have different densities and weights. The weight members 150 are configured to be at least partially received within the receiver 140 to connect the weight members 150 to the head 102, and each weight member 150 has connecting structure that is configured to engage the body 108 of the head 102 to retain the weight member 150 to the receiver 140. In this embodiment, all of the weight members 150 have substantially identical connecting structure, however in another embodiment, one or more of the weight members 150 may have a different connecting structure. Various different types of connecting structure can be used to engage different portions of the body 108, such as by engaging the inner or outer surface 134, 135 of the rear wall 132 and/or the inner walls 142 of the receiver. FIGS. 5-7 illustrate some example embodiments of weight members 150A-C having different connecting structures 152A-C, each configured for connection to the head 102 of FIGS. 2-4.

FIG. 5 illustrates one example of a weight member 150A having connecting structure 152A configured for connection to the head 102 of FIGS. 2-4, and FIG. 8 illustrates the weight member 150A connected to the head 102. The connecting structure 152A of the weight member 150A of FIG. 5 includes tapered walls 154A that are tapered similarly to the inner walls 142 of the receiver 140, so that the walls 154A of the weight member 150A engage the walls 142 of the receiver 140 to retain the weight member 150A in the receiver 140, as shown in FIG. 8. Additionally, the connecting structure 152A includes a bonding material 156A, such as adhesive, cement, etc., between the walls 154A of the weight member 150A and the walls 142 of the receiver 140 to connect the weight member 150A to the receiver 140. The bonding material 156A in one embodiment may be a thermoset or other thermally-active material that can be used to set the weight member 150A in place, but can be heated to melt or release the bonding material 156A to allow the weight member 150A to be re-set or interchanged. In another embodiment, the weight member 150A may be retained in the receiver 140 by a friction or interference fit, or the structures may have interlocking or other complementary structure. In other embodiments, the weight member 150A may have different connecting structure, including a structure that may be connectable to the body 108 using an integral joining technique, as well as structure that utilizes additional pieces configured to secure the weight member 150A to the body 108.

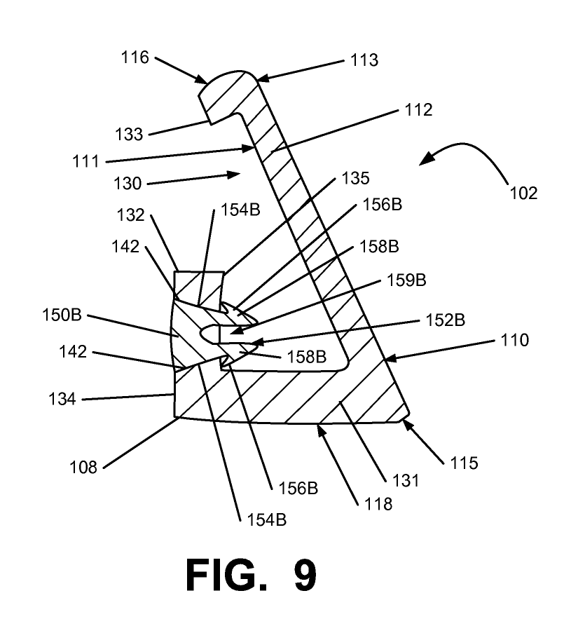

FIG. 6 illustrates another example of a weight member 150B having connecting structure 152B configured for connection to the head 102 of FIGS. 2-4, and FIG. 9 illustrates the weight member 150B connected to the head 102. The connecting structure 152B of the weight member 150B of FIG. 6 includes a pair of flexible tabs 156B extending from the body of the weight member 150B, which are configured to engage the inner walls 142 of the receiver 140 and the inner surface 135 of the rear wall 132 to retain the weight member 150B in the receiver 140. The flexible tabs 156B are positioned on flexible legs 158B with a gap 159B between the legs 158B to permit the legs 158B and tabs 156B to flex inward to pass through the receiver 140 during insertion. Once inserted, the legs 158B and tabs 156B flex back outwardly so that the tabs 156B engage the inner surface 135 of the rear wall 132, as shown in FIG. 9. The weight member 150B also has tapered walls 154B that are tapered similarly to the inner walls 142 of the receiver 140. In another embodiment, a different number or configuration of tabs, or another flexible connecting structure, may be used.

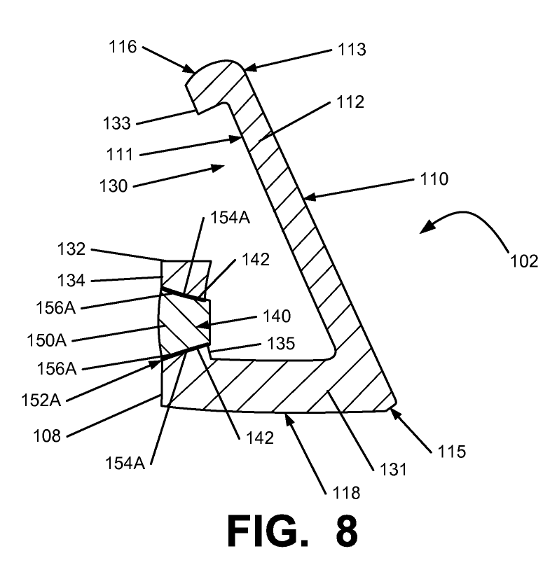

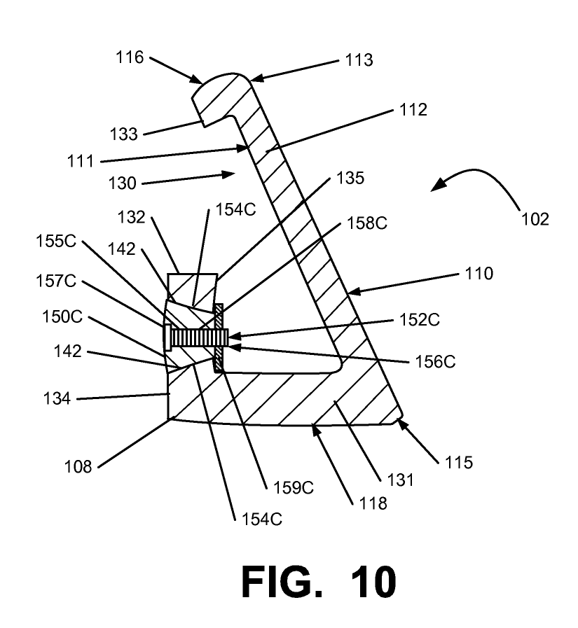

FIG. 7 illustrates another example of a weight member 150C having connecting structure 152C configured for connection to the head 102 of FIGS. 2-4, and FIG. 10 illustrates the weight member 150C connected to the head 102. The connecting structure 152C of the weight member 150C of FIG. 7 includes a fastener assembly 156C that engages the inner surface 135 of the rear wall 132 to retain the weight member 150C in the receiver 140. In this embodiment, the fastener assembly 156C includes a fastener 157C, such as a bolt or screw, that is received in a hole 158C in the body of the weight member 150C, as well as an anchor 159C (such as a nut) that engages the inner surface 135 of the rear wall 132. In one embodiment, the anchor 159C may be elongated to a length that is smaller than the width of the elliptical receiver 140 but larger than the height of the receiver 140, such as the elliptical anchor 159C shown in FIG. 7. As such, the anchor 159C can fit through the receiver 140 into the inner cavity 130 of the head 102, but the rotational action of the fastener 157C is sufficient to turn the anchor 159C to the configuration shown in FIG. 10, so that it cannot be pulled back through the receiver 140. As shown in FIGS. 9-10, the fastener 157C and the hole 158C have complementary threading structure 155C to connect the fastener 157C to the weight member 150C. In another embodiment, a different fastener assembly 156C may be used. For example, a fastener with an expanding tip structure may be used, in which case the anchor 159C may be omitted. In another example, a non-rotary fastener may be used, such as a nail, staple, clamp, or other fastener.

FIGS. 11-12 illustrate another embodiment of an iron-type head 202. Many features of the head 202 of FIGS. 11-12 are similar to the features of the head 102 shown in FIGS. 2-4, and such similar features are identified by similar reference numerals in FIGS. 11-12 using the “2xx” series of reference numerals. Accordingly, certain features of the head 202 of FIGS. 11-12 that are already described above may described below using less detail, or may not be described at all. In this embodiment, the rear wall 232 of the head 202 has a receiver 240 that is positioned more proximate the toe 222 than the heel 220, such that the elongated receiver 240 extends from behind the hot zone of the face 212 toward the toe 222. The receiver 240 is otherwise configured similarly to the receiver 140 of FIGS. 2-4, and is configured for connection to the weight members 150, 150A-C or similar weight members.

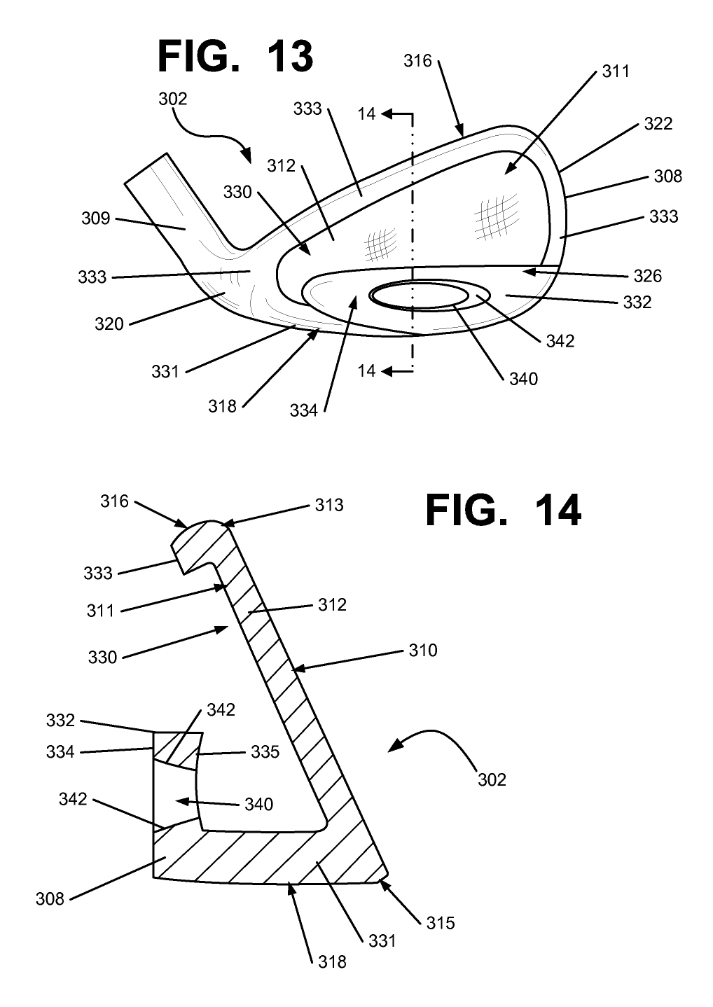

FIGS. 13-14 illustrate another embodiment of an iron-type head 302. Many features of the head 302 of FIGS. 13-14 are similar to the features of the head 102 shown in FIGS. 2-4, and such similar features are identified by similar reference numerals in FIGS. 13-14 using the “3xx” series of reference numerals. Accordingly, certain features of the head 302 of FIGS. 13-14 that are already described above may described below using less detail, or may not be described at all. In this embodiment, the rear wall 332 of the head 302 has a receiver 340 that is positioned proximate the center of the head 302, such that the center of the elongated receiver 340 is positioned approximately behind the hot zone of the face 312. The receiver 340 is otherwise configured similarly to the receivers 140, 240 of FIGS. 2-4 and 11-12, and is configured for connection to the weight members 150, 150A-C or similar weight members.

The heads 102, 202, 302 may be assembled as parts of a set of golf clubs 100 having progressive weighting. For example, in one embodiment, a club head 102 as shown in FIGS. 2-4, with a weight member 150 positioned more proximate the heel 120 of the head 102 may be used for longer irons, and a club head 202 as shown in FIGS. 11-12, with a weight member 150 positioned more proximate the toe 222 of the head 202 may be used for shorter irons. The position of the weight member 150 and receiver 140 may be progressively moved from heel 120 toward the toe 122 as the club heads 102 progress from longer to shorter irons. Additionally, the selection of differently-weighted weight members 150, 150A-C can provide further options for progressive weighting. As an example, a club head 302 as shown in FIGS. 13-14, with a weight member 150 positioned proximate the center of the head 302 may be used for mid-range irons. In another example embodiment, combinations of club heads 102, 202, 302 and weight members 150, 150A-C such as those shown above can be used to customize one or more golf clubs, or even a set of golf clubs, for a particular golfer, based on swing characteristics of the golfer for a particular club or clubs. For example, if a golfer has trouble closing the face 112 while swinging a particular iron, more weight may be added to the heel 120 of that club head 102. As another example, the weighting of the head 102 may be adjusted to compensate for a common hitting pattern, such as if a golfer frequently strikes the ball in a specific location on the face 112. In further embodiments, still other types of progressive weighting can be utilized. It is understood that any features described herein with respect to other embodiments, including the various embodiments of receivers 440, 440A, 540, 640, 840 and weight members 450, 450A, 550, 650, 850, may be used in conjunction with the heads 102, 202, 302 of FIGS. 2-4 and 11-14.

FIGS. 15-16 illustrate another embodiment of an iron-type head 402, which has another embodiment of a weight member 450 connected thereto. Many features of the head 402 of FIGS. 15-16 are similar to the features of the heads 102, 202, 302 shown in FIGS. 2-4 and 11-14, and such similar features are identified by similar reference numerals in FIGS. 15-16 using the “4xx” series of reference numerals. Accordingly, certain features of the head 402 of FIGS. 15-16 that are already described above may described below using less detail, or may not be described at all. In this embodiment, the head 402 has a rear wall 432 that extends across the entire rear cavity 430, from the peripheral wall 433 on the heel 420 to the peripheral wall 433 on the toe 422, and down to the sole member 431. Additionally, in this embodiment, the rear wall 432 has a receiver 440 that is located behind the hot zone of the face 412 and has a substantially circular shape. As shown in FIG. 16, the receiver 440 is formed by an aperture that extends completely through the rear wall 432, from the outer surface 434 to the inner surface 435. Additionally, the receiver 440 has inner walls 442 that are threaded to engage the weight member 450, and a countersunk portion 444 adjacent the outer surface 434 of the rear wall 432. The weight member 450 shown in FIGS. 15-16 is configured to be connected to the rear wall 432 and received within the receiver 440. The weight member 450 has connecting structure 452 that includes a threaded portion 454 adapted to engage the threaded inner walls 442 of the receiver 440, and an enlarged head portion 453 that is adapted to be received within the countersunk portion 444 of the receiver 440. It is understood that a plurality of weight members 450 having similar configurations may be provided, with each weight member 450 having different weighting, as described above. It is further understood that other weight members having different configurations may be adapted for connection to the receiver 440 in FIGS. 15-16.

FIG. 17 illustrates another embodiment of a weight member 450A and a receiver 440A that are configured for use in a golf club head similar to the head 402 in FIGS. 15-16. It is noted that FIG. 17 is a plan view showing the weight member 450A and receiver 440A as seen on the inner surface 435 of the rear wall 432 in the embodiment of FIGS. 15-16. In this embodiment, the connecting structure 452A of the weight member 450A includes a pair of posts 454A extending from the sides of the weight member 450A at the inner end thereof, in lieu of the threaded portion 454 as shown in FIGS. 15-16. The receiver 440A has a pair of passages 446A extending from either side of the aperture of the receiver 440A that are configured to receive the posts 454A therethrough during insertion. Once the weight member 450A has been completely inserted into the receiver 440A so that the posts 454A extend past the passages 446A, the weight member 450A can be rotated into a locked position, causing the posts 454A to engage the inner surface 435 of the rear wall 432 to retain the weight member 450A in the receiver 440A. In FIG. 17, the weight member 450A would be rotated clockwise to the locked position and counterclockwise back to the unlocked position, such as if the weight member 450A is to be removed. Additionally, the receiver 440A has two countersunk slots 448A on the inner surface 435 of the rear wall 432, and the slots 448A provide room for the posts 454A to rotate to lock the weight member 450A into the locked position. It is understood that the weight member 450A and receiver 440A may have an enlarged head portion 453 and a countersunk portion 444, respectively, similarly to the weight member 450 in FIGS. 15-16. In further embodiments, a different type of rotary locking structure may be used, and it is understood that the configuration of the weight member 450A of FIG. 17 and its corresponding locking structure 452A can be used with any other embodiments described herein.

FIGS. 18-19 illustrate another embodiment of an iron-type head 502, which has another embodiment of a weight member 550 connected thereto. Many features of the head 502 of FIGS. 18-19 are similar to the features of the heads 102, 202, 302, 402 shown in FIGS. 2-4 and 11-16, and such similar features are identified by similar reference numerals in FIGS. 18-19 using the “5xx” series of reference numerals. Accordingly, certain features of the head 502 of FIGS. 18-19 that are already described above may described below using less detail, or may not be described at all. In this embodiment, the head 502 is a traditional blade-type iron configuration, and has a solid body 508 with no rear cavity. The rear wall 532 in this embodiment may also be recognized as the rear surface 511 of the face, due to the solid body construction. Peripheral walls 533, including a sole member 531 extend rearward from the face 512 to meet with the rear wall 532. Additionally, in this embodiment, the rear wall 532 has a receiver 540 that is located between the hot zone of the face 512 and the toe 522 of the head 502, and has a substantially circular shape. As shown in FIG. 19, the receiver 540 is formed by an aperture that extends into the body 508, through a portion of the thickness of the body 508. The receiver 540 is constructed similarly to the receiver 440 of FIGS. 15-16, having inner walls 542 that are threaded to engage the weight member 550, and a countersunk portion 544 adjacent the outer surface 534 of the rear wall 532. The weight member 550 shown in FIGS. 18-19 is configured to be connected to the rear wall 532 and received within the receiver 540. The weight member 550 has connecting structure 552 that includes a threaded portion 554 adapted to engage the threaded inner walls 542 of the receiver 540, and an enlarged head portion 553 that is adapted to be received within the countersunk portion 544 of the receiver 540. It is understood that a plurality of weight members 550 having similar configurations may be provided, with each weight member 550 having different weighting, as described above. It is further understood that other weight members having different configurations may be adapted for connection to the receiver 540 in FIGS. 18-19.

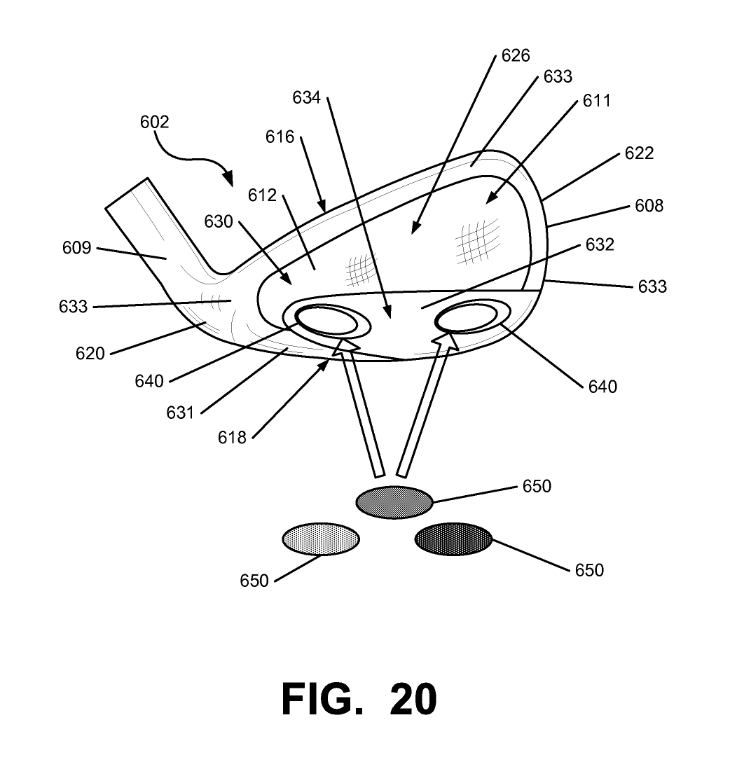

FIG. 20 illustrates another embodiment of an iron-type head 602, which is configured for connection to another embodiment of a weight member 650. Many features of the head 602 of FIG. 20 are similar to the features of the heads 102, 202, 302, 402, 502 shown in FIGS. 2-4, 11-16, and 18-19 and such similar features are identified by similar reference numerals in FIG. 20 using the “6xx” series of reference numerals. Accordingly, certain features of the head 602 of FIG. 20 that are already described above may described below using less detail, or may not be described at all. In this embodiment, the head 602 is configured similarly to the heads 102, 202, 302 of FIGS. 2-4 and 11-14, having peripheral walls 633, including a sole member 631, extending rearward from the face 612 and a rear wall 632 extending across the rear cavity 630. In this embodiment, the rear wall 632 has two receivers 640 that are elongated and substantially oval or elliptical in shape and configured similarly to the receiver 140 illustrated in FIGS. 2-4 and described above. One of the receivers 640 is located proximate the heel 620 of the head 602, and the other receiver 640 is located proximate the toe 622. The weight members 650 shown in FIG. 20 are configured to be received in either of the two receivers 640 and may have a connecting structure similar to one of the weight members 150A-C in FIGS. 2-10. The plurality of weight members 650 illustrated in FIG. 20 have similar configurations, but each have different weighting through the use of doping materials, as described above. This configuration provides for a wide variety of selected or customized weighting, as weight can be added in various degrees to either or both the heel 620 or toe 622 of the head 602. It is understood that in one embodiment, one of the weight members 650 connected to the head 602 may have no doping material, to further bias the weight distribution of the head 602 toward the heel 620 or toe 622. It is further understood that other weight members having different configurations may be adapted for connection to the receiver 640 in FIG. 20.

FIG. 21 illustrates another embodiment of an iron-type head 702, which is configured for connection to another embodiment of a weight member 750. Many features of the head 702 of FIG. 20 are similar to the features of the heads 102, 202, 302, 402, 502, 602 shown in FIGS. 2-4, 11-16, and 18-20 and such similar features are identified by similar reference numerals in FIG. 21 using the “7xx” series of reference numerals. Accordingly, certain features of the head 702 of FIG. 21 that are already described above may described below using less detail, or may not be described at all. In this embodiment, the head 702 is configured similarly to the heads 102, 202, 302 of FIGS. 2-4 and 11-14, having peripheral walls 733, including a sole member 731, extending rearward from the face 712 and a rear wall 732 extending across the rear cavity 730. In this embodiment, the rear wall 732 has a receiver 740 that is substantially oval or elliptical in shape and configured similarly to the receiver 140 illustrated in FIGS. 2-4 and described above. The receiver 740 in FIG. 21 is slightly more elongated than the receiver 140 of FIGS. 2-4, and is relatively centered on the head 702, similarly to the receiver 340 of FIGS. 14-15. The weight member 750 shown in FIG. 21 is configured to be received in the receiver 740 and may have a connecting structure similar to one of the weight members 150A-C in FIGS. 2-10. Additionally, the weight member 750 has a weight gradient, as illustrated by the hatching lines in FIG. 21, which may be created by using, for example, different doping materials and/or an uneven distribution or volume fraction of one or more doping materials within the weight member 750. This weight gradient creates a heavier end 751A and a lighter end 751B relative to each other. As shown in FIG. 21, the weight member 750 and the receiver 740 are symmetrical, so the weight member 750 can be inserted into the receiver 740 in two different configurations, by rotating the weight member 750 by 180°. Accordingly, this configuration permits the option to create greater weighting toward the heel 720 or the toe 722 of the head 702. In further embodiments, a weight member 750 may be used that has a different weight gradient, such as a top-to-bottom gradient or a more complex gradient, or a different uneven weight distribution. Still further, a receiver 740 and a gradient weight member 750 having different shapes may permit for additional options for weighting, including a square weight member that has four different symmetrical positions, or a circular weight member that can be rotated to a nearly infinite number of symmetrical positions. It is further understood that other weight members having different configurations may be adapted for connection to the receiver 740 in FIG. 20.

FIGS. 22-23 illustrate another example embodiment of a ball striking device 800 in the form of a wood golf club (such as a driver) or other wood-type club, including fairway wood, a hybrid club, etc. The golf club 800 shown in FIGS. 22-23 includes a ball striking head 802 configured to strike a ball in use and a shaft 804 connected to the ball striking head 802 and extending therefrom. Although the head 802 is a wood-type head, which differs from the iron type heads 102, et seq., described above, many features of the head 802 of FIGS. 22-23 are similar to the features of the head 102 shown in FIGS. 2-4, and such similar features are identified by similar reference numerals in FIGS. 22-23 using the “8xx” series of reference numerals. Accordingly, certain features of the head 802 of FIGS. 22-23 that are already described above may described below using less detail, or may not be described at all.

The ball striking head 802 of the golf club 800 of FIGS. 22-23has a face 812 connected to a body 808, with a hosel 809 extending therefrom. Any desired hosel and/or head/shaft interconnection structure may be used without departing from this invention, including those described above. The head 802 has an enclosed volume, as the club head 802 is a wood-type club head designed for use as a driver, intended to hit the ball accurately over long distances. In other applications, such as for a different type of golf club, the head 802 may be designed to have different dimensions and configurations. For example, in the embodiment shown in FIGS. 22-23, the club head 802 may have a volume of at least 400 cc, and in some structures, at least 450 cc, or even at least 460 cc. If instead configured as a fairway wood, the head may have a volume of 120 cc to 230 cc, and if configured as a hybrid club, the head may have a volume of 85 cc to 140 cc. Other appropriate sizes for other club heads may be readily determined by those skilled in the art.

In the embodiment illustrated in FIGS. 22-23, the body 808 of the head 802 has a squared or rectangular rear profile. In other embodiments, the body 808 of the head 802 can have another shape or profile, including a rounded shape or other any of a variety of other shapes. It is understood that such shapes may be configured to distribute weight away from the face 812 and/or the geometric/volumetric center of the head 802, in order to create a lower center of gravity and/or a higher moment of inertia. The golf club 800 may include a shaft 804 connected to or otherwise engaged with the ball striking head 802 as illustrated schematically in FIG. 22, and as similarly shown in FIGS. 1-2 and described above.

In the illustrative embodiment illustrated in FIGS. 22-23, the head 802 has a hollow structure defining an inner cavity (not shown). In one embodiment, the inner cavity 823 may be filled with air. However, in other embodiments, the head could be filled with another material, such as foam. In still further embodiments, the solid materials of the head may occupy a greater proportion of the volume, and the head may have a smaller cavity or no inner cavity at all. It is understood that the inner cavity may not be completely enclosed in some embodiments.

The face 812 in FIGS. 22-23 is located at the front 824 of the head 802, and has an outer surface 810 and an inner surface (not shown) opposite the outer surface 810. As shown, the outer surface 810 of the face 812 is substantially flat, and has a plurality of outer or peripheral edges, including a top edge 813, a bottom edge 815, and lateral edges (including heel edge 817 and toe edge 819). In the illustrative embodiment shown in FIGS. 22-23, the outer or ball striking surface 810 of the face 812 is inclined (i.e., at a loft angle), to give the ball a desired lift and spin when struck. The loft angle of the face 812 may be different in different embodiments, to affect the trajectory of the ball. Additionally, in this embodiment, the face 812 has a plurality of face grooves 821 on the ball striking surface 810, which do not extend across the hot zone at the center of the face 812. In another embodiment, such as a fairway wood head a hybrid wood-type head, the face 812 may have grooves 821 that extend across at least a portion of the hot zone of the face 812.

It is understood that the face 812, the body 808, and/or the hosel 809 can be formed as a single piece or as separate pieces that are joined together. The face 812 may be formed as part of a face frame member with the body 808 being partially or wholly formed by one or more separate pieces connected to the face frame member, with a wall or walls extending rearward from the edges of the face 812. This configuration (not shown) is also known as a “cup face” structure. Additionally, at least a portion of the body 808 may be formed as a separate piece or pieces joined to the wall(s) of the face frame member, such as by a backbody member attached to the cup face structure, composed of a single piece or multiple pieces. These pieces may be connected by an integral joining technique, such as welding, cementing, or adhesively joining Other known techniques for joining these parts can be used as well, including many mechanical joining techniques, and including releasable mechanical engagement techniques such as various fasteners. If desired, the hosel 809 may be integrally formed as part of the face frame member. Further, a gasket (not shown) may be included between the cup face structure and the backbody member.

The head 802 of FIGS. 22-23 includes two receivers 840 located on the sole 818 of the body 808, each of which is configured to receive a weight member 850 therein. The receivers 840 and weight members 850 in this embodiment are configured similarly to the receiver 440 and weight member 450 in FIGS. 15-16, such that the receiver 840 has threaded side walls (e.g. 442), and the weight member 850 has a threaded portion (e.g. 454) that engage in complementary fashion to connect the weight member 850 to the receiver 840. In another embodiment, another configuration may be used to connect the weight members 850 to the receivers 840, including the configuration illustrated in FIG. 17, or any other configurations described herein. It is understood that a plurality of weight members 850 having similar configurations may be provided to be connectable to either receiver 840, with each weight member 850 having different weighting, as described above.

Several different embodiments have been described above, including the various embodiments of golf clubs 100, 800 and heads 102, 102A, 202, 302, 402, 502, 602, 802 and portions thereof described herein. It is understood that any of the features of these various embodiments may be combined and/or interchanged. For example, as described above, various different combinations of club heads 102, et seq. with differently configured receivers 140, et seq. that are adapted for use with differently configured weight members 150, et seq. may be used, including the configurations described herein, variations or combinations of such configurations, or other configurations. In further embodiments, at least some of the features described herein can be used in connection with other configurations of iron-type clubs, wood-type clubs, other golf clubs, or other types of ball-striking devices.

Heads 102, et seq. incorporating the features disclosed herein may be used as a ball striking device or a part thereof. For example, a golf club 100 as shown in FIG. 1 may be manufactured by attaching a shaft or handle 104 to a head that is provided, such as the head 102 as described above. “Providing” the head, as used herein, refers broadly to making an article available or accessible for future actions to be performed on the article, and does not connote that the party providing the article has manufactured, produced, or supplied the article or that the party providing the article has ownership or control of the article. In other embodiments, different types of ball striking devices can be manufactured according to the principles described herein. In one embodiment, a set of golf clubs can be manufactured, where at least one of the clubs has a head with a receiver and a weight member other features described herein.

Additionally, as described above, the head 102, et seq., golf club 100, et seq., or other ball striking device may be fitted or customized for a person by custom fitting, which may include selecting a weight member 150, et seq. from a plurality of weight members 150, et seq. having different weighting characteristics, and connecting the weight member 150, et seq. to the body 108, et seq. of a club head 102, et seq., such that at least a portion of the weight member 150, et seq. is received in a receiver 140, et seq. on the body 108, et seq. Additionally, the plurality of weight members 150, et seq. may be identical or substantially identical in size and shape, and/or may all be configured for connection to the same receiver 140, et seq. As also described above, the weight members 150, et seq. can be used to create a set of golf clubs 100 having heads 102, et seq. with progressive or customized weighting characteristics. Such customization may include analyzing a golfer's hitting patterns and using one or more weight members 150, et seq. to adjust the weighting of the club head 102, et seq. based on a location of the face 112, et seq. where impacts most frequently occur during use by the user. Such customization may also include raising or lowering the center of gravity of the head 102, et seq., in order to affect the trajectory of the shot. Such customization may further include shifting the weight of the head 102, et seq. more toward the heel 120, et seq. or the toe 122, et seq. Golfers who have trouble closing the face 112, et seq. on a swing may benefit from more weight in the heel 120, et seq., and golfers who have no trouble closing the face 112, et seq. or who over-close the face 112, et seq. on a swing may benefit from more weight in the toe 122, et seq. Further, one or more weight members 150, et seq. previously connected to the head 102, et seq. may be removed and replaced by a differently weighted weight member 150, et seq., providing further customization options. Various other different configurations are possible, and various other club heads may be designed for various performance characteristics.

The ball striking devices and heads therefor as described herein provide many benefits and advantages over existing products. For example, the use of different weight members in specific locations on a club head can be used to adjust the weighting of the club head, including the weight, weight distribution, moment of inertia, etc. Additionally, weight members as described herein can be used with a set of golf clubs to create progressive weighting or customized weighting among the clubs of the set. Further, the use of a filled or doped polymer material allows a plurality of weight members to be provided, each having similar sizes, shapes, physical properties (such as strength and flexibility), etc., yet having a wide variety of different weighting configurations, including different weights, densities, and weight distributions. Still further, the polymer material of the weight members, when connected behind the face of the club head, can provide sound and/or vibration dampening, which can in turn provide improved sound and feel during impact. It is understood that the polymer material used in the weight members could be selected based on its sound and/or vibration dampening properties. Other benefits and advantages are recognizable by those skilled in the art.

While the invention has been described with respect to specific examples including presently preferred modes of carrying out the invention, those skilled in the art will appreciate that there are numerous variations and permutations of the above described systems and methods. Thus, the spirit and scope of the invention should be construed broadly as set forth in the appended claims.

What is claimed is:

1. An iron-type golf club head comprising:
a face defined by a plurality of peripheral edges including a bottom edge and having a ball striking surface and an inner surface opposite the ball striking surface;
a body connected to the face and extending rearward from the face, the body comprising a sole member extending rearward from the bottom edge of the face, a rear wall extending upward from a rear of the sole member, and a rear cavity defined at least partially by the sole member, the rear wall, and the inner surface of the face, the rear wall having a receiver therein; and
a weight member connected to the rear wall and being at least partially received by the receiver, the weight member having connecting structure that engages the rear wall to retain the weight member to the receiver, wherein the weight member comprises a polymer material having a doping material embedded therein, the doping material having a different density than the polymer material.

2. The iron-type golf club head of claim 1, wherein the receiver has a generally oval shape that is elongated in a heel-to-toe direction, and the weight member has a generally oval shape that is complementary to the shape of the receiver to be received in the receiver.

3. The iron-type golf club head of claim 1, wherein the connecting structure of the weight member comprises a fastener that engages the rear wall to retain the weight member to the receiver.

4. The iron-type golf club head of claim 1, wherein the connecting structure of the weight member comprises a flexible tab that engages the rear wall to retain the weight member to the receiver.

5. The iron-type golf club head of claim 1, wherein the connecting structure comprises a threaded portion that engages complementary threading in the receiver to retain the weight member to the receiver.

6. The iron-type golf club head of claim 1, further comprising a bonding material between the weight member and the receiver to retain the weight member to the receiver.

7. The iron-type golf club head of claim 1, further comprising a second weight member comprising a polymer material having a doping material embedded therein, the doping material of the second weight member having a different density than the polymer material, and the second weight member having a different density than the weight member, wherein the second weight member is configured for connection to the rear wall in place of the weight member, such that the second weight member is at least partially received by the receiver, the second weight member having connecting structure configured to engage the rear wall to retain the second weight member to the receiver.

8. The iron-type golf club head of claim 7, wherein the weight member and the second weight member are part of a plurality of weight members, each weight member comprising a polymer material having a doping material embedded therein, the doping material of the each weight member having a different density than the polymer material, and each weight member having a different density than each of the other weight members, wherein the plurality of weight members are configured for alternate connection to the rear wall, such that each weight member is at least partially received by the receiver when connected to the rear wall.

9. The iron-type golf club head of claim 7, wherein the connecting structure of the weight member and the connecting structure of the second weight member are substantially identical.

10. The iron-type golf club head of claim 7, wherein the doping material of the weight member is different from the doping material of the second weight member and has a different density than the doping material of the second weight member.

11. The iron-type golf club head of claim 1, wherein the weight member has a weight gradient such that one portion of the weight member has a higher density than another portion of the weight member.

12. An iron-type golf club comprising the iron-type golf club head of claim 1 and a shaft connected to the head.

13. A set of iron-type golf clubs comprising:
a first iron-type golf club having an iron-type golf club head comprising:
a face defined by a plurality of peripheral edges including a bottom edge and having a ball striking surface and an inner surface opposite the ball striking surface,
a body connected to the face and extending rearward from the face, the body comprising a sole member extending rearward from the bottom edge of the face, a rear wall extending upward from a rear of the sole member, and a rear cavity defined at least partially by the sole member, the rear wall, and the inner surface of the face, the rear wall having a receiver therein, and
a weight member connected to the rear wall and being at least partially received by the receiver, the weight member having connecting structure that engages the rear wall to retain the weight member to the receiver, wherein the weight member comprises a polymer material having a doping material embedded therein, the doping material having a different density than the polymer material; and
a second iron-type golf club having a second iron-type golf club head comprising:
a face defined by a plurality of peripheral edges including a bottom edge and having a ball striking surface and an inner surface opposite the ball striking surface, the ball striking surface having a face angle that is different from a face angle of the ball striking surface of the first golf club;
a body connected to the face and extending rearward from the face, the body comprising a sole member extending rearward from the bottom edge of the face, a rear wall extending upward from a rear of the sole member, and a rear cavity defined at least partially by the sole member, the rear wall, and the inner surface of the face, the rear wall having a receiver therein, wherein the receiver of the second golf club is substantially identical to the receiver of the first golf club and is located in a different location on the rear wall as compared to the receiver of the first golf club; and
a weight member connected to the rear wall such that at least a portion of the weight member is received by the receiver, the weight member comprising a polymer material having a doping material embedded therein, the doping material having a different density than the polymer material.

14. The set of claim 13, wherein the weight member of the first golf club and the weight member of the second golf club are interchangeable with each other.

15. The set of claim 14, wherein the weight member of the first golf club has a connecting structure that engages the rear wall to retain the weight member to the receiver, and the second golf club has a connecting structure that engages the rear wall to retain the weight member to the receiver, wherein the connecting structure of the weight member of the first golf club and the connecting structure of the weight member of the second golf club are substantially identical, to enable the weight members to be interchanged.

16. The set of claim 14, wherein the weight member of the first golf club and the weight member of the second golf club are part of a plurality of weight members that are interchangeable with each other and are each configured to be connected to the rear wall of the first and second golf clubs such that at least a portion of the weight member is received by the receiver of the respective golf club.

17. The set of claim 16, wherein each of the plurality of weight members has a different density.

18. The set of claim 13, wherein the first golf club further comprises a bonding material between the weight member and the receiver to retain the weight member to the receiver, and the second golf club further comprises a bonding material between the weight member and the receiver to retain the weight member to the receiver.

19. A golf club head comprising:
a face defined by a plurality of peripheral edges and having a ball striking surface configured for striking a ball;
a body connected to the face and extending rearward from the peripheral edges of the face, the body having a receiver therein; and
a weight member connected to the body and being at least partially received by the receiver, the weight member having connecting structure that engages a portion of the body to retain the weight member to the receiver, wherein the weight member comprises a polymer material having a doping material embedded therein, the doping material having a different density than the polymer material.

20. The golf club head of claim 19, wherein the head is an iron-type golf club head, and the body comprises a sole member extending rearward from a bottom edge of the face and a rear wall connected to the sole member, wherein the receiver is positioned in the rear wall of the body.

21. The golf club head of claim 20 wherein the body further comprises a plurality of peripheral walls extending rearward from the peripheral edges of the face, the peripheral walls including the sole member, and a cavity defined between the peripheral walls, the rear wall, and an inner surface of the face, such that at least a portion of the rear wall is spaced from the inner surface of the face.

22. The golf club head of claim 20 wherein the head has a blade-type configuration, such that the body further comprises a plurality of peripheral walls extending rearward from the peripheral edges of the face, the peripheral walls including the sole member, the peripheral walls and the rear wall combining to form a solid body, and wherein the receiver extends from the rear wall into the solid body.

23. The golf club head of claim 19, wherein the head is a wood-type golf club head, and the body further comprises an inner cavity enclosed by the body and the face, the body having a sole surface, wherein the receiver is located in the sole surface of the body.

24. The golf club head of claim 19, wherein the connecting structure of the weight member comprises a structure selected from a group consisting of: a flexible tab that engages the rear wall to retain the weight member to the receiver; a threaded portion that engages complementary threading in the receiver to retain the weight member to the receiver; a bonding material between the weight member and the receiver to retain the weight member to the receiver; and a fastener that engages the body to retain the weight member to the receiver.

25. The golf club head of claim 19, further comprising a second weight member comprising a polymer material having a doping material embedded therein, the doping material of the second weight member having a different density than the polymer material, and the second weight member having a different density than the weight member, wherein the second weight member is configured for connection to the body in place of the weight member, such that the second weight member is at least partially received by the receiver, the second weight member having connecting structure configured to engage the portion of the body to retain the second weight member to the receiver.

26. The golf club head of claim 19, wherein the receiver has a generally oval shape that is elongated in a heel-to-toe direction, and the weight member has a generally oval shape that is complementary to the shape of the receiver to be received in the receiver.

27. The golf club head of claim 19, wherein the weight member has a weight gradient such that one portion of the weight member has a higher density than another portion of the weight member.

28. The golf club head of claim 27, wherein the weight member further comprises a second doping material having a higher density than the doping material, wherein the doping material and the second doping material are distributed within the weight member to create the weight gradient.

29. The golf club head of claim 27, wherein the doping material is unevenly distributed within the weight member to create the weight gradient.

30. A golf club comprising the golf club head of claim 19 and a shaft connected to the head.

31. A kit comprising:
a golf club head comprising:
a face defined by a plurality of peripheral edges and having a ball striking surface configured for striking a ball; and
a body connected to the face and extending rearward from the peripheral edges of the face, the body having a receiver therein; and
a plurality of weight members each being configured for alternate connection to the body, such that each weight member is at least partially received by the receiver when connected to the body, each weight member comprising a polymer material having a doping material embedded therein, the doping material of each weight member having a different density than the polymer material, and each weight member having a different weighting than each other weight member.

32. The kit of claim 31, wherein each weight member having a different weighting than each other weight member comprises having at least one of a different total weight, a different average density, and a different weight distribution.

33. The kit of claim 31, wherein the doping material of a first of the weight members is a different material than the doping material of a second of the weight members, the doping material of the first weight member having a different density than the doping material of the second weight member.

34. The kit of claim 31, wherein a first of the weight members has a greater volume fraction of doping material than a second of the weight members.

35. The kit of claim 31, wherein each weight member has connecting structure configured to engage a portion of the body to retain the weight member to the receiver.

36. The kit of claim 35, wherein all of the weight members have substantially identical connecting structure.

37. A method comprising:
providing a golf club head comprising:
a face defined by a plurality of peripheral edges and having a ball striking surface configured for striking a ball; and
a body connected to the face and extending rearward from the peripheral edges of the face, the body having a receiver therein; and
connecting a weight member to the body, such that the weight member is at least partially received by the receiver, the weight member comprising a polymer material having a doping material embedded therein, the doping material having a different density than the polymer material.

38. The method of claim 37, further comprising:
removing the weight member from the body; and
connecting a second weight member to the body to replace the weight member, such that the second weight member is at least partially received by the receiver, the second weight member comprising a polymer material having a doping material embedded therein, the doping material having a different density than the polymer material.

39. The method of claim 37, further comprising:
providing a plurality of weight members each being configured for alternate connection to the body, such that each weight member is at least partially received by the receiver when connected to the body, each weight member comprising a polymer material having a doping material embedded therein, the doping material of each weight member having a different density than the polymer material, and each weight member having a different density than each other weight member; and
selecting the weight member from the plurality of weight members, based on a weighting of the weight member, prior to connecting the weight member to the body.
